(19) United States
(12) Patent Application Publication
(10) Pub. No.: US 2004/0002269 A1
(43) Pub. Date: Jan. 1, 2004

(54) Explosion proof eletrical systems

(76) Inventor: Michael Jahn, Hambuehren (DE)

Correspondence Address: William B Patterson, Moser Patterson & Sheridan, Suite 1500, 3040 Post Oak Boulevard, Houston, TX, 77056, US

(21) Appl. No.: 10/362,381

(22) PCT Filed: Aug. 23, 2001
(86) PCT No.: PCT/GB01/03816

(30) Foreign Application Priority Data
Aug. 26, 2000 (GB) 0020988.2

(51) Int. Cl. H01R 9/22

(52) U.S. Cl. 439/894

(57) ABSTRACT

An explosion proof electrical system comprises a rigid outer casing (2), with at least one rigid internal wall (4, 5) dividing the inside of the casing (2) into at least two chambers (3). Adjacent chambers (3) communicate via an aperture (7), with electrical equipment (8) being contained in each chamber (3). The electrical equipment (8) is interconnected via electrical connections (10) passing through the or each aperture (7). The outer casing (2) and the or each rigid internal walls (4, 5) are made of a substantially non-conductive material, or of a conductive material in which case the casing and/or walls is/are coupled to ground potential.

The present invention relates to explosion proof electrical systems and in particular though not necessarily to explosion proof electrical systems for use on an oil platform.

In environments where unconfined flammable gases, vapours, and liquids are present, or where there is a risk that they may be present, tight controls must be placed on the types of equipment which can be operated. One such environment is that which exists in the vicinity of the wellhead on an oil or gas platform where potentially explosive gases and vapours are likely to be present. Similarly hazardous environments are present in many factories and refineries.

Electrical equipment may be capable of generating a spark to ignite a flammable gas or vapour and is therefore the subject of very strict safety requirements. These requirements specify for example maximum permissible voltages and currents. It is expected that, in the event of a short circuit occurring (or other fault such as a cable break or the mis-connection of a wire to a connector), equipment satisfying these requirements will not generate a spark. Another potential ignition source is excessive heating. Therefore, safety requirements are also specified for wire diameter (resistance) to minimise resistive heating effects. Other requirements may be for example the integrity of the housing for an electrical system and the integrity and structure of electrical connectors.

Equipment which meets the relevant safety requirements is termed “intrinsically safe”. The operation of such equipment requires no special precautions such as enclosure within a sealed moulding and/or operation within an inert atmosphere. Problems arise where it is desirable to operate two or more intrinsically safe systems in close proximity to one another, and where the combined ratings of the systems exceed the intrinsically safe ratings.

It will be appreciated that the intrinsically safe limits place severe restrictions on the capabilities of a piece of electrical equipment (in practice only 3 Watts may be available to a single intrinsically safe system). Particularly in view of the increasing automation of wellhead operations (such as making and breaking tubing), the limits are becoming increasingly troublesome.

It is an object of the present invention to provide an explosion proof housing for electrical equipment, which is capable of safely housing electrical equipment consuming a relatively large amount of power.

According to a first aspect of the present invention there is provided an explosion proof system, the system comprising:

a rigid outer casing;

at least one internal wall for dividing the inside of the casing into at least two chambers, adjacent chambers communicating via an aperture arranged to accept a signal connector;

electrical components placed in each of said chambers;

a signal connector or connectors coupling said electrical components together and passing through said aperture(s); and

means for substantially electrically isolating electrical components in each of said chambers from components in the other chamber(s).

The outer casing of embodiments of the present invention meets the relevant explosion proof requirements, as does the internal wall (or walls). Each chamber into which the internal space of the casing is divided is capable of housing electrical equipment meeting the intrinsically safe requirements.

Preferably, the or each inner wall is rigid.

Preferably, said outer casing and the or each rigid internal walls are made of a substantially non-conductive material, or of a conductive material in which case the casing and/or walls is/are coupled to zero potential. Alternatively, the casing and internal walls may be coated or covered in a non-conductive material or a conductive material coupled to zero potential.

Preferably, said signal connector is arranged in use to interconnect electrical equipment in the chambers. However, the aperture is small enough to prevent the passage of materials which might result in a short circuit occurring between the electrical equipment in the two chambers. The or each signal connector may be an electrical connector, e.g. a ribbon cable. Alternatively, the connector may comprise optical fibre. The connector may be armoured.

Preferably, said electrical connector comprises at least one power supply line. More preferably, said power supply line is connected in parallel to the electrical equipment of each chamber and passes through said aperture(s).

Preferably, each chamber comprises an isolation interface coupled between the electrical equipment contained in the chamber and the signal connector(s) entering the chamber. The isolation interface may be an optical interface, magnetic interface, and/or an electrical isolation circuit. Such an arrangement prevents the transfer of excessive energy between chambers whilst allowing the transfer of data.

The casing typically has an aperture therein through which a signal connector connects the inside of the casing to external equipment, e.g. a remote control unit and a power supply.

According to a second aspect of the present invention there is provided an explosion proof electrical system, the system comprising:

a plurality of housings, each housing having a rigid outer casing containing electrical equipment, the electrical equipment having an isolation interface; and

a signal connector extending between at least two housings and being connected to the isolation interfaces of the at least two housings to allow data to be transmitted between the electrical equipment via the isolation interfaces,

wherein the electrical equipment contained within each housing is intrinsically safe.

For a better understanding of the present invention and in order to show how the same may be carried into effect reference will now be made by way of example to the accompanying drawings in which:

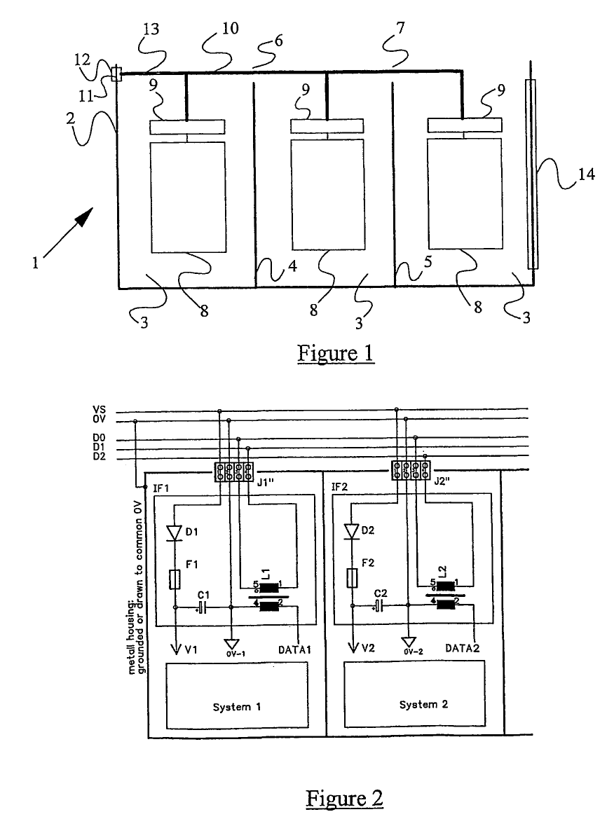

FIG. 1 illustrates an explosion proof system;

FIG. 2 illustrates an electrical isolation circuit of the system of FIG. 1; and

FIG. 2 illustrates an alternative explosion proof system.

FIG. 1 illustrates an electrical system 1 which has been designed to meet the explosion proof requirements of EN50014 (general Ex rules) and EN50020 (intrinsically safe equipment) for operating in the wellhead environment of an oil or gas platform. The system comprises an outer casing 2 which is of a strong, rigid non-electrostatic plastic and insulating material (alternatively the casing 2 may be of a conductive material in which case the casing must be connected to a zero potential, e.g ground or a common zero). The casing is able to withstand the greatest shocks liable to occur in the working environment. The internal space of the casing 2 is sub-divided into three chambers 3 by two internal walls 4,5. These walls 4,5 are made of the same material as the casing 1 and as such are equally capable of withstanding shocks. The walls 4,5 are formed integrally with the casing 2, but provide for a small elongate aperture 6,7 communicating between adjacent chambers 3.

Each chamber 3 contains electrical equipment 8, comprising for example one or more circuit boards and connected components. Each piece of electrical equipment meets the intrinsically safe requirements. Connected to or integrated into each circuit board is an electrical isolation interface 9. FIG. 2 illustrates in more detail two chambers of the electrical system 1, containing respective electrical equipment (systems 1 and 2). The systems 1 and 2 are coupled to a power and data bus (see below) by respective isolation interface circuits comprising a diode and capacitor and inductor arrangements. A diode (D1,D2) of each system allows power to flow from a power line of the bus to the system, but not in the reverse direction.

Electrical connectors in the form of ribbon cables 10 are coupled between the isolation interfaces 9 of adjacent chambers. The cables 10 together (via the isolation interfaces 9) form a power and data bus. The cables 10 pass through the apertures 6,7. The apertures 6,7 are dimensioned such that it is not possible for small pieces of metal and other material to pass through them. This prevents a possible short circuit occurring between adjacent chambers 3.

One of the chambers 3 has an aperture 11 formed in a wall thereof to allow an electrical connector 12 to enter the chamber from the exterior of the housing 1. This connector 12 is coupled to an external remote control unit and a power supply (not shown). As well as data pins, the connector 12 comprises power supply pins (AC or DC). The connector 12 is coupled to the isolation interface 9 of a first of the chambers 3 via an armoured ribbon cable 13. Power and data is transmitted to (and from) each of the chambers via the bus (formed by cables 9,13 and the isolation interfaces 9).

It will be understood that electrical power is coupled across an isolation interface 9, from a cable 9,13 to a circuit board, whilst the transmission of power in the reverse direction is prevented. However, where necessary, the isolation interfaces 9 allow the bi-directional transfer of data. The use of isolation interfaces 9 allows in some circumstances the bus 9,13 to be a non-Ex system part whilst the chambers 3 each contain an IS system.

FIG. 1 illustrates a liquid crystal display (LCD) 14 arranged at one end of the housing 1. Whilst the LCD 14 may for example be penetrated by some object forced into it, it will be appreciated that the object will be prevented from passing from the top chamber to the intermediate chamber by the internal wall 5. Thus, no short circuit between the chambers 3 will occur.

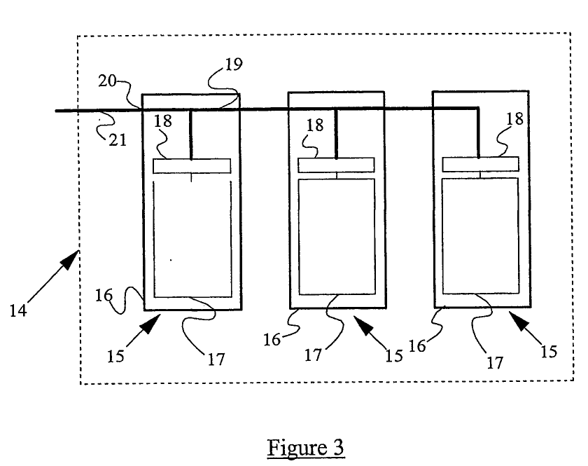

FIG. 3 illustrates an alternative explosion proof system 14 suitable for use in the wellhead environment of an oil or gas platform. The system comprises three separate housings 15, each having an outer casing 16 which is of a strong, rigid plastic and insulating material. The inside of each housing contains electrical equipment 17 and an isolation interface 18. As such, each housing corresponds substantially to a chamber 3 of the system described with reference to FIGS. 1 and 2. The electrical equipment 17 of each housing 15 meets the intrinsically safe requirements. Electrical connectors (not shown) provided through each casing 16, and ribbon cables 19, allow the electrical equipment 17 of each housing to communicate. An electrical connector 20 in one of the housings 15 is connected to an external remote control unit and power supply (not shown), with a cable 21 connecting the connector 20 to the isolation interface 18 of that housing. Power and data is communicated between housings 15 by the bus formed by cables 19 and the isolation interfaces 18.

In both of the embodiments described above, the complete system may have a higher electrical rating than is normal for a single piece of equipment, providing that the electrical equipment of each individual chamber (or housing in the case of the embodiment of FIG. 3) is intrinsically safe, in view of the degree of isolation (both mechanical and electrical) between the chambers (or housings).

It will be appreciated by the person of skill in the art that various modifications may be made to the above described embodiments without departing from the scope of the present invention. For example, the or each casing may be made of a conductive material (e.g. metal), providing that the casing(s) is(are) connected to ground potential. Either solution will prevent sparks being generated by electrical activity. The systems described above may be combined together, e.g. in a rack, to provide a “super system”, with a common bus interconnecting the systems.

1. An explosion proof system for use on an oil or gas platform, the system comprising:
a rigid outer casing;
at least one internal wall for dividing the inside of the casing into at least two chambers, adjacent chambers communicating via an aperture arranged to accept a signal connector;
electrical components placed in each of said chambers, the components within each chamber meeting intrinsically safe requirements;
a power and data bus passing through said aperture(s) for providing power to said electrical components and for communicating data between electrical components in different chambers; and
the power and data bus comprising means for substantially electrically isolating electrical components in each of said chambers from the bus cable and from components in the other chamber(s).

2. A system according to claim 1, wherein said internal wall is rigid.

3. A system according to claim 1 or 2, wherein said outer casing and the or each internal wall are made of a substantially non-conductive material, or of a conductive material in which case the casing and/or walls is/are coupled to zero potential.

4. A system according to any one of the preceding claims, wherein the aperture is small enough to prevent the passage of materials which might result in a short circuit occurring between the electrical equipment in the two chambers.

5. A system according to any one of the preceding claims, wherein said means for substantially electrically isolating electrical components in each of said chambers comprises an isolation interface.

6. An explosion proof electrical system for use on an oil or gas platform, the system comprising:
a plurality of housings, each housing having a rigid outer casing containing electrical equipment; and
a power and data bus extending between at least two housings and comprising an isolation interface within each of the housings for connection to electrical equipment thereof to provide power to the electrical equipment and to allow data to be transmitted between the electrical equipment via the isolation interfaces,
the power rating of each housing is equal to or less than an explosion proof rating whilst the power rating of the system exceeds the explosion proof rating.
